(19) United States
(12) Patent Application Publication
(10) Pub. No.: US 2026/0166465 A1
(43) Pub. Date: Jun. 18, 2026

(54) SYSTEM AND METHOD OF THE ADSORPTION OF VOLATILE ORGANIC COMPOUNDS

(71) Applicant: CALGON CARBON CORPORATION, Moon Township, PA (US)

(72) Inventors: Walter G. TRAMPOSCH, Moon Township, PA (US); Joseph Edward COLE, New Castle, PA (US)

(73) Assignee: CALGON CARBON CORPORATION, Moon Township, PA (US)

(21) Appl. No.: 19/382,706

(22) Filed: Nov. 7, 2025

Related U.S. Application Data
(60) Provisional application No. 63/717,939, filed on Nov. 8, 2024.

(51) Int. Cl. B01D 53/04; B01J 20/20; B01J 20/28; B01J 20/30; B01J 20/32; F02M 35/024

(52) U.S. Cl. CPC B01D 53/04; B01J 20/20; B01J 20/28011; B01J 20/28026; B01J 20/28061; B01J 20/3007; B01J 20/321; B01J 20/324; F02M 35/02441; B01D 2253/102; B01D 2257/708; B01D 2259/4516; B01D 2259/4566

(57) ABSTRACT

Systems and method of removing volatile organic compounds from gaseous streams are described herein. The systems include an airbox having activated carbon mixed into a polypropylene matrix. The airbox may be used in the adsorption of gasoline vapors through a vehicle air intake manifold to reduce the emissions of gasoline vapors from motorized vehicles.

### CROSS-REFERENCE TO RELATED APPLICATIONS

This application claims benefit of and priority to U.S. Provisional Patent Application No. 63/717,939 titled “SYSTEM AND METHOD OF THE ADSORPTION OF VOLATILE ORGANIC COMPOUNDS” filed Nov. 8, 2024, the disclosure of which is incorporated by reference herein in its entirety.

### FIELD

The present disclosure relates generally to an airbox that is designed to reduce the evaporative emissions from vehicles and other devices that are powered by internal combustion engines (ICEs).

### BACKGROUND

Internal combustion engines (ICEs) are used for many applications where power is required from an engine that is compact and lightweight. In a common ICE configuration, fuel is combusted within a combustion chamber, which is a confined space bounded, for example, by cylinder walls, a cylinder, a head, and one or more valves and/or one or more ports for intake and exhaust gases. In certain ICEs, a spark plug is included to ignite the fuel.

In many ICEs, volatile light petrochemicals, such as gasoline, are the fuel. Gasoline is a useful fuel because it vaporizes easily at room temperature (about 20° C.) and mixes rapidly with air. These two properties contribute to complete and efficient combustion when gasoline is added to combustion chambers via gasoline direct injection (GDI), port injection, throttle body injection, or carburetors.

While gasoline volatility is beneficial for the reasons described above, it creates a pollution control challenge known as evaporative emissions. Evaporative emissions of gasoline contain various volatile organic compounds (VOCs) that react with ultraviolet (UV) radiation and air and are a significant contributor to smog (ground level ozone). A typical automobile that is powered by a gasoline-powered ICE includes a fuel tank that is open to the atmosphere to relieve the pressure of gasoline vapors as the gasoline slowly vaporizes. This open fuel tank design is connected to an adsorptive canister that contains a sorbent, such as activated carbon. The sorbent adsorbs gasoline vapors while the ICE is not operating and later, at pre-determined times, a valve permits fresh engine intake air to contact the sorbent and thereby desorb the gasoline vapors. The intake air, now containing entrained gasoline vapors, is sent to the combustion chamber to be burned in the ICE.

Recent emissions regulations continue to become more stringent. For example, the Sealed Housing for Evaporative Determination (“SHED”) test is currently used to enclose an entire tank system, motorcycle, or even automobile in a chamber to precisely measure the gasoline evaporative emissions from that entire system or vehicle. Recent regulations such as those from the US Environmental Protection Agency (EPA) or California Air Resources Board (CARB) are now so stringent that controlling vapor emissions from the fuel tank may be insufficient when other parts of the ICE fuel delivery system are releasing VOCs.

To address the challenge, air intake evaporative emissions control devices (EVAP) have been attached to or otherwise integrated into the air intakes of ICEs. These air intake evaporative emissions control devices adsorb the evaporative emissions emanating from the fuel delivery system components such as the fuel injectors, and fresh intake air later desorbs the VOCs for combustion in the ICE. However, the air intake evaporative emissions control devices may themselves cause problems because they occupy additional space in the already crowded engine bay of an automobile. The present disclosure therefore describes a novel air intake box that reduces gasoline evaporative emissions emanating from fuel delivery system components, such as fuel injectors and carburetors, without occupying additional space or requiring additional parts to be installed in a typical automobile engine bay.

### SUMMARY

In one embodiment, an airbox for the adsorption of volatile organic compounds includes a sorbent material product including a polymer matrix and a sorbent material positioned within the polymer matrix. The polymer matrix includes one or more of polyethylene, polypropylene, polyvinylchloride, and polytetrafluoroethylene, and the sorbent material is present within the polymer matrix in an amount of about 5 wt. % to about 40 wt. %.

In some embodiments, the sorbent material is present within the polymer matrix in an amount of about 10 wt. % to about 30 wt. %.

In some embodiments, the sorbent material is present within the polymer matrix in an amount of about 20 wt. %.

In some embodiments, the sorbent material includes one or more of activated carbon, reactivated carbon, carbon nanotubes, graphenes, natural and synthetic zeolite, silica, silica gel, alumina, zirconia, and diatomaceous earths.

In some embodiments, the airbox has a butane working capacity (BWC) of about 0.0010 g/cm² to about 0.0025 g/cm².

In some embodiments, the airbox further includes a housing that at least partially encapsulates the polymer matrix.

In one embodiment, a method for adsorbing volatile organic compounds includes providing a sorbent material product including a polymer matrix and a sorbent material positioned within the polymer matrix, and contacting the sorbent material product with an air stream including volatile organic compounds. The polymer matrix includes one or more of polyethylene, polypropylene, polyvinylchloride, and polytetrafluoroethylene, and the sorbent material is present within the polymer matrix in an amount of about 5 wt. % to about 40 wt. %.

In some embodiments, the sorbent material is present within the polymer matrix in an amount of about 10 wt. % to about 30 wt. %.

In some embodiments, the sorbent material is present within the polymer matrix in an amount of about 20 wt. %.

In some embodiments, the sorbent material includes one or more of activated carbon, reactivated carbon, carbon nanotubes, graphenes, natural and synthetic zeolite, silica, silica gel, alumina, zirconia, and diatomaceous earths.

In some embodiments, the sorbent material product has a butane working capacity (BWC) of about 0.0010 g/cm² to about 0.0025 g/cm².

In some embodiments, the sorbent material product has a butane working capacity (BWC) of about 0.0015 g/cm² to about 0.0020 g/cm².

In one embodiment, a vehicle includes an airbox configured for the adsorption of volatile organic compounds, the airbox including a sorbent material product including a polymer matrix and a sorbent material positioned within the polymer matrix. The polymer matrix includes one or more of polyethylene, polypropylene, polyvinylchloride, and polytetrafluoroethylene, and the sorbent material is present within the polymer matrix in an amount of about 5 wt. % to about 40 wt. %.

In some embodiments, the sorbent material is present within the polymer matrix in an amount of about 10 wt. % to about 30 wt. %.

In some embodiments, the sorbent material is present within the polymer matrix in an amount of about 20 wt. %.

In some embodiments, the sorbent material includes one or more of activated carbon, reactivated carbon, carbon nanotubes, graphenes, natural and synthetic zeolite, silica, silica gel, alumina, zirconia, and diatomaceous earths.

In some embodiments, the airbox has a butane working capacity (BWC) of about 0.0010 g/cm² to about 0.0025 g/cm².

In some embodiments, the airbox has a butane working capacity (BWC) of about 0.0015 g/cm² to about 0.0020 g/cm².

In some embodiments, the airbox is positioned within an air intake manifold of the vehicle.

### BRIEF DESCRIPTION OF DRAWINGS

FIG. 1 depicts a conventional automobile air intake system.

FIG. 2 depicts an illustrative automobile air intake system according to an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

As used herein, the term “sorbent material” is meant to encompass all known materials from any source that are capable of absorbing or adsorbing liquids and/or gases. For example, sorbent materials include, but are not limited to, activated carbon, reactivated carbon, carbon nanotubes, graphenes, natural and synthetic zeolite, silica, silica gel, alumina, zirconia, and diatomaceous earths.

As used herein, the term “airbox” refers to all parts of an air intake system. For example, an airbox may include an air filter housing, intake manifold, throttle body, mass airflow sensor, intake air temperature sensor, and associated ducting and connections that direct air flow from the atmosphere to the engine cylinders.

The scope of the present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

### DETAILED DESCRIPTION

This disclosure is not limited to the particular systems, devices, and methods described, as these may vary. The terminology used in the description is for the purpose of describing the particular versions or embodiments only and is not intended to limit the scope.

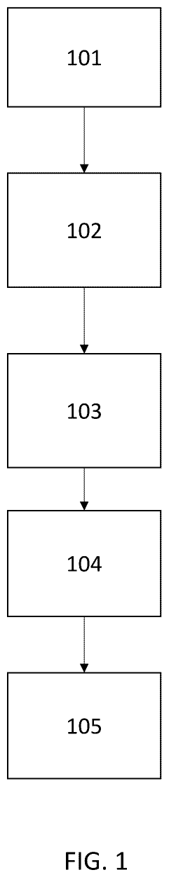

FIG. 1 shows a conventional automobile air intake system 100. In the air intake system 100, atmospheric air 101 is drawn into an air filter box 102. The air filter box 102 contains a pleated air filter (not shown) that removes small particulate matter from the air that is drawn into the air filter box 102 by the engine. The air filter box 102 also serves to muffle sounds emanating from the ICE, which is desirable to reduce noise emissions. After the atmospheric air 101 is filtered by the air filter box 102, it proceeds through an intake manifold 104. The intake manifold 104 comprises a plurality of tubes configured to distribute the atmospheric air 101 to intake valves 105 at each of the cylinders of the ICE. The conventional automobile air intake system 100 further comprises an EVAP adsorbing device 103 positioned between the air filter box 102 and the intake manifold 104.

### Products

Systems may be assembled to aid in the adsorption of volatile organic compound emissions, particularly in the context of motorized vehicle applications. In some embodiments, an airbox for the adsorption of volatile organic compounds comprises a sorbent material product, such as activated carbon, incorporated within a polymer matrix, such as polypropylene. The sorbent material product may be configured to allow a gaseous stream to flow through the sorbent material product and adsorb volatile organic compounds using the sorbent material within the polymer matrix. In some embodiments, the airbox may be positioned within a vehicle. In some embodiments, the sorbent material is present within the polymer matrix in an amount of about 20 wt. %. The use of the sorbent material product provides a simple and efficient method for efficient volatile organic compound emission adsorption without the need for additional parts or devices.

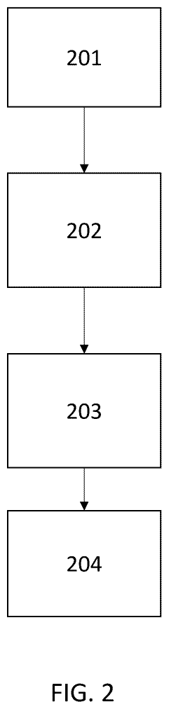

FIG. 2 depicts an illustrative automobile air intake system 200 according to an embodiment. In the air intake system 200, atmospheric air 201 is drawn into an airbox 202. The airbox 202 contains a sorbent material product incorporated within a polymer matrix configured to filter small particulate matter from the air that is drawn into the airbox 202. The sorbent material in the airbox 202 is configured to adsorb volatile organic compounds. After the atmospheric air 201 is filtered by the airbox 202, it proceeds through an intake manifold 203. The intake manifold 203 comprises a plurality of tubes configured to distribute the atmospheric air 201 to intake valves 204 at each of the cylinders of the ICE. The use of the airbox 202 comprising the polymer matrix and the sorbent material enables the automobile air intake system 200 to filter small particulate matter and adsorb volatile organic compounds without the use of an EVAP adsorbing device.

In some embodiments, the sorbent material product may be formed by adding activated carbon to polypropylene prior to a molding or extrusion process. This may result in a sorbent material product that maintains its structural integrity while also being effective for the adsorption of volatile organic compounds. This may result in a reduction in the amount of volatile organic compounds that are emitted from the airbox.

In some embodiments, an airbox 202 for the adsorption of volatile organic compounds from a gaseous stream. In some embodiments, the airbox 202 comprises a sorbent material product. In some embodiments, the sorbent material product comprises a polymer matrix and a sorbent material positioned within the polymer matrix. The polymer matrix may comprise any polymer effective for maintaining a sorbent material. In some embodiments, the polymer matrix may comprise one or more of polyethylene, polypropylene, polyvinylchloride, and polytetrafluoroethylene.

The sorbent material may be present within the polymer matrix in any amount effective for the removal of volatile organic compounds from a gaseous stream. In some embodiments, the sorbent material is present within the polymer matrix in an amount effective for the removal of volatile organic compounds from a gaseous stream. In some embodiments, the sorbent material is present within the polymer matrix in amount of about 5 wt. %, about 10 wt. %, about 15 wt. %, about 20 wt. %, about 25 wt. %, about 30 wt. %, about 35 wt. %, about 40 wt. %, or any value or range of values between any two of these values. In some embodiments, the sorbent material is present within the polymer matrix in amount of about 5 wt. % to about 40 wt. %, or about 10 wt. % to about 30 wt. %.

The sorbent material may comprise of any material effective for the removal of volatile organic compounds from a gaseous stream. In some embodiments, the sorbent material comprises one or more of activated carbon, reactivated carbon, carbon nanotubes, graphenes, natural and synthetic zeolite, silica, silica gel, alumina, zirconia, and diatomaceous earths, and combinations thereof. In some embodiments, the sorbent material comprises one or more of granular activated carbon or powdered activated carbon. The sorbent material may comprise any average particle size effective for the removal of volatile organic compounds from a gaseous stream. In some embodiments, the sorbent material has an average particle size of about 0.001 mm, about 0.005 mm, about 0.010 mm, about 0.015 mm, about 0.020 mm, about 0.025 mm, about 0.030 mm, about 0.035 mm, about 0.040 mm, about 0.045 mm, about 0.050 mm, about 0.055 mm, about 0.060 mm, about 0.065 mm, about 0.070 mm, about 0.075 mm, about 0.080 mm, about 0.085 mm, about 0.090 mm, about 0.095 mm, about 0.100 mm, about 0.11 mm, about 0.12 mm, about 0.13 mm, about 0.14 mm, about 0.15 mm, about 0.16 mm, about 0.17 mm, about 0.18 mm, about 0.19 mm, about 0.20 mm, about 0.25 mm, about 0.30 mm, about 0.35 mm, about 0.40 mm, about 0.45 mm, about 0.50 mm, about 0.55 mm, about 0.60 mm, about 0.65 mm, about 0.70 mm, about 0.75 mm, about 0.80 mm, about 0.85 mm, about 0.90 mm, about 0.95 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 3.1 mm, about 3.2 mm, about 3.3 mm, about 3.4 mm, about 3.5 mm, about 3.6 mm, about 3.7 mm, about 3.8 mm, about 3.9 mm, about 4.0 mm, or any value or range of values between any two of these values.

The airbox 202 may comprise any butane working capacity (BWC) effective for the removal of volatile organic compounds from a gaseous stream. In some embodiments, the airbox 202 has a BWC of about 0.0010 g/cm², about 0.0015 g/cm², about 0.0020 g/cm², about 0.0025 g/cm², about 0.0030 g/cm², about 0.0035 g/cm², about 0.0040 g/cm², about 0.0045 g/cm², about 0.0050 g/cm², or any value or range of values between any two of these values.

In some embodiments, the airbox 202 has a BWC of about 0.0010 g/cm² to about 0.0025 g/cm² or about 0.0015 g/cm² to about 0.0020 g/cm².

The sorbent material product may have any density effective for the removal of volatile organic compounds from a gaseous stream. In some embodiments, the sorbent material product has a density of about 0.80 g/cc, about 0.81 g/cc, about 0.82 g/cc, about 0.83 g/cc, about 0.84 g/cc, about 0.85 g/cc, about 0.86 g/cc, about 0.87 g/cc, about 0.88 g/cc, about 0.89 g/cc, about 0.90 g/cc, about 0.91 g/cc, about 0.92 g/cc, about 0.93 g/cc, about 0.94 g/cc, about 0.95 g/cc, about 0.96 g/cc, about 0.97 g/cc, about 0.98 g/cc, about 0.99 g/cc, about 1.00 g/cc, about 1.01 g/cc, about 1.02 g/cc, about 1.03 g/cc, about 1.04 g/cc, about 1.05 g/cc, about 1.06 g/cc, about 1.07 g/cc, about 1.08 g/cc, about 1.09 g/cc, about 1.10 g/cc, about 1.11 g/cc, about 1.12 g/cc, about 1.13 g/cc, about 1.14 g/cc, about 1.15 g/cc, about 1.16 g/cc, about 1.17 g/cc, about 1.18 g/cc, about 1.19 g/cc, about 1.20 g/cc, about 1.21 g/cc, about 1.22 g/cc, about 1.23 g/cc, about 1.24 g/cc, about 1.25 g/cc, or any value or range of values between any two of these values.

In some embodiments, a vehicle may be provided that includes an airbox 202 configured for the adsorption of volatile organic compounds. The airbox 202 in the vehicle may include a sorbent material product comprising a polymer matrix and a sorbent material positioned within the polymer matrix. The polymer matrix in the airbox 202 of the vehicle may be composed of one or more polymers such as polyethylene, polypropylene, polyvinylchloride, and polytetrafluoroethylene. The sorbent material may be present within the polymer matrix in varying amounts, for instance, in an amount of about 5 wt. % to about 40 wt. %. In some cases, the sorbent material may be present within the polymer matrix in an amount of about 10 wt. % to about 30 wt. %. In other cases, the sorbent material may be present within the polymer matrix in an amount of about 20 wt. %.

In some embodiments, the airbox 202 may further comprise a housing. In some embodiments, the housing may at least partially encapsulate the sorbent material product. In some embodiments, the housing may serve to protect the sorbent material product and may also aid in directing the flow of the gaseous stream through the sorbent material product. In some embodiments, the housing may be composed of a material that is permeable to the gaseous stream, allowing the gaseous stream to pass through the housing and into contact with the sorbent material product. The housing may be of any suitable shape or size to accommodate the sorbent material product and to fit within an air intake manifold of a vehicle.

In some embodiments, the sorbent material product may be formed by adding a sorbent material to a polymer and forming the polymer into a sorbent material product. The polymer may be formed by any method of forming polymers known to one of ordinary skill in the art. In some embodiments, the polymer is formed by one of an extrusion or a molding process. In some embodiments, the sorbent material may be mixed with the polymer in a manner that allows for a uniform distribution of the sorbent material within the polymer matrix. This may result in a sorbent material product that has a consistent adsorption capacity throughout its structure

In some embodiments, the airbox 202 may be used in a vehicle to reduce the emissions of volatile organic compounds. The airbox 202 may be positioned in a location within the vehicle where it can effectively adsorb volatile organic compounds from a gaseous stream. In some embodiments, the airbox 202 may be positioned in an air intake manifold of the vehicle. The airbox 202 may prevent the escape of volatile organic compounds through the air intake manifold, thereby reducing the emissions of volatile organic compounds from the vehicle.

### Methods

Methods may be performed to remove volatile organic compounds from gaseous streams using the above-described products. In some embodiments, a method for adsorbing volatile organic compounds comprises providing a sorbent material product. In some embodiments, the sorbent material product comprises a polymer matrix and a sorbent material positioned within the polymer matrix. In some embodiments, the polymer matrix may comprise one or more of polyethylene, polypropylene, polyvinylchloride, and polytetrafluoroethylene. In some embodiments, the sorbent material may be present within the polymer matrix in an amount of about 5 wt. % to about 40 wt. %, about 10 wt. % to about 30 wt. %, or about 20 wt. %.

In some embodiments, the method may further comprise contacting the sorbent material product with an air stream comprising volatile organic compounds. The air stream may be any gaseous stream that includes volatile organic compounds. In some embodiments, the air stream may be a gaseous stream that is emitted from a vehicle. The sorbent material product may adsorb the volatile organic compounds from the air stream, thereby reducing the amount of volatile organic compounds that are emitted into the environment. In some embodiments, the method may be performed within a vehicle. In such an embodiment, the method may further comprise desorbing the volatile organic compounds when an engine of the vehicle is started.

### EXAMPLES

### Example 1: Sorbent Material Product BWC Testing

Samples with a composition of 20 wt. % activated carbon and 80 wt. % polypropylene mixtures and samples with a composition of 100 wt. % polypropylene were produced for butane working capacity (BWC) testing. For each sample, polypropylene was melted and then molded into a 100 mm by 150 mm by 3 mm sorbent material product. For the samples including activated carbon, the activated carbon was added to the polypropylene after melting and before the sorbent material product was molded. The surface area weight, and density of each sample was then measured, with the results provided in Table 1.

TABLE 1

| | | | | | Surface | | |
|---|---|---|---|---|---|---|---|
| | | Height | Width | Thickness | Area | Weight | Density |
| Sample | Material Composition | (mm) | (mm) | (mm) | (cm²) | (g) | (g/cc) |
| 1 | 100% Polypropylene | 152 | 99 | 2.95 | 316 | 40.25 | 0.91 |
| 2 | 100% Polypropylene | 150 | 100 | 2.90 | 315 | 40.32 | 0.93 |
| 3 | 100% Polypropylene | 150 | 103 | 2.85 | 323 | 37.67 | 0.86 |
| 4 | 80% Polypropylene | 151 | 103 | 3.35 | 328 | 50.50 | 0.97 |
| | 20% Activated Carbon | | | | | | |
| 5 | 80% Polypropylene | 150 | 99 | 3.40 | 314 | 47.50 | 0.94 |
| | 20% Activated Carbon | | | | | | |
| 6 | 80% Polypropylene | 150 | 99 | 3.10 | 312 | 44.25 | 0.96 |
| | 20% Activated Carbon | | | | | | |
| 7 | 80% Polypropylene | 151 | 103 | 3.15 | 326 | 49.85 | 1.02 |
| | 20% Activated Carbon | | | | | | |
| 8 | 80% Polypropylene | 152 | 99 | 2.99 | 316 | 44.69 | 0.99 |
| | 20% Activated Carbon | | | | | | |

The BWC of each sample was then tested. BWC testing included drying each sample to remove moisture. Each sample was placed in a separate testing container between two pieces of foam. Each container received a flow of butane at a rate of 0.60 L/min, and the mass of the sample was recorded at 20 minutes. Butane was run through each canister at a rate of 0.60 L/min for additional 10-minute increments until the mass of the sample remained constant and the sample was saturated. Each sample was purged using air at a rate of 0.30 L/min for a total of 12 L. Each purged sample was weighed and a BWC was calculated using the difference between the saturated mass and the purged mass. The samples of 100% polypropylene yielded an average BWC of about 0.0013 g/cm² as compared to the samples of 20 wt. % activated carbon and 80 wt. % polypropylene with an average BWC of about 0.0024 g/cm². The BWC of polypropylene is assumed to be 0, with the 0.0013 g/cm² resulting from butane that has not been adsorbed but trapped within the testing container. As such, the calculated average BWC for the sorbent material product comprising activated carbon is calculated to be 0.0011 g/cm².

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. An airbox for the adsorption of volatile organic compounds, the airbox comprising:
a sorbent material product comprising a polymer matrix and a sorbent material positioned within the polymer matrix,
wherein the polymer matrix comprises one or more of polyethylene, polypropylene, polyvinylchloride, and polytetrafluoroethylene, and
wherein the sorbent material is present within the polymer matrix in an amount of about 5 wt. % to about 40 wt. %.

2. The airbox of claim 1, wherein the sorbent material is present within the polymer matrix in an amount of about 10 wt. % to about 30 wt. %.

3. The airbox of claim 1, wherein the sorbent material is present within the polymer matrix in an amount of about 20 wt. %.

4. The airbox of claim 1, wherein the sorbent material comprises one or more of activated carbon, reactivated carbon, carbon nanotubes, graphenes, natural and synthetic zeolite, silica, silica gel, alumina, zirconia, and diatomaceous earths.

5. The airbox of claim 1, wherein the airbox has a butane working capacity (BWC) of about 0.0010 g/cm² to about 0.0025 g/cm².

6. The airbox of claim 1, further comprising a housing that at least partially encapsulates the polymer matrix.

7. A method for adsorbing volatile organic compounds, the method comprising:
providing a sorbent material product comprising a polymer matrix and a sorbent material positioned within the polymer matrix; and
contacting the sorbent material product with an air stream comprising volatile organic compounds,
wherein the polymer matrix comprises one or more of polyethylene, polypropylene, polyvinylchloride, and polytetrafluoroethylene, and
wherein the sorbent material is present within the polymer matrix in an amount of about 5 wt. % to about 40 wt. %.

8. The method of claim 7, wherein the sorbent material is present within the polymer matrix in an amount of about 10 wt. % to about 30 wt. %.

9. The method of claim 7, wherein the sorbent material is present within the polymer matrix in an amount of about 20 wt. %.

10. The method of claim 7, wherein the sorbent material comprises one or more of activated carbon, reactivated carbon, carbon nanotubes, graphenes, natural and synthetic zeolite, silica, silica gel, alumina, zirconia, and diatomaceous earths.

11. The method of claim 7, wherein the sorbent material product has a butane working capacity (BWC) of about 0.0010 g/cm² to about 0.0025 g/cm².

12. The method of claim 7, wherein the sorbent material product has a butane working capacity (BWC) of about 0.0015 g/cm² to about 0.0020 g/cm².

13. A vehicle comprising:
an airbox configured for the adsorption of volatile organic compounds, the airbox comprising:
a sorbent material product comprising a polymer matrix and a sorbent material positioned within the polymer matrix,
wherein the polymer matrix comprises one or more of polyethylene, polypropylene, polyvinylchloride, and polytetrafluoroethylene, and
wherein the sorbent material is present within the polymer matrix in an amount of about 5 wt. % to about 40 wt. %.

14. The vehicle of claim 13, wherein the sorbent material is present within the polymer matrix in an amount of about 10 wt. % to about 30 wt. %.

15. The vehicle of claim 13, wherein the sorbent material is present within the polymer matrix in an amount of about 20 wt. %.

16. The vehicle of claim 13, wherein the sorbent material comprises one or more of activated carbon, reactivated carbon, carbon nanotubes, graphenes, natural and synthetic zeolite, silica, silica gel, alumina, zirconia, and diatomaceous earths.

17. The vehicle of claim 13, wherein the airbox has a butane working capacity (BWC) of about 0.0010 g/cm² to about 0.0025 g/cm².

18. The vehicle of claim 13, wherein the airbox has a butane working capacity (BWC) of about 0.0015 g/cm² to about 0.0020 g/cm².

19. The vehicle of claim 13, wherein the airbox is positioned within an air intake manifold of the vehicle.
